(19) United States
(12) Patent Application Publication
(10) Pub. No.: US 2016/0293320 A1
(43) Pub. Date: Oct. 6, 2016

(54) INDUCTOR DEVICE AND METHOD OF MANUFACTURING THE SAME

(71) Applicant: Samsung Electro-Mechanics Co., Ltd., Suwon-si (KR)

(72) Inventors: In-Seok Kim, Suwon-si (KR); Yong-Jin Park, Suwon-si (KR); Young-Gwan Ko, Seoul (KR); Youn-Soo Seo, Suwon-si (KR); Myung-Sam Kang, Hwaseong-si (KR); Tae-Hong Min, Hwaseong-si (KR)

(73) Assignee: Samsung Electro-Mechanics Co., Ltd., Suwon-si (KR)

(21) Appl. No.: 15/003,925

(22) Filed: Jan. 22, 2016

(30) Foreign Application Priority Data
Apr. 6, 2015 (KR) 10-2015-0048218

(51) Int. Cl. H01F 27/28; H01F 27/29; H01F 41/04; H01F 27/32

(52) U.S. Cl. CPC H01F 27/2804; H01F 27/32; H01F 27/29; H01F 41/042; H01F 2027/2809

(57) ABSTRACT

Disclosed is an inductor device and method of manufacturing the same. The inductor device includes an insulating layer, a coil pattern formed on two opposing surfaces of the insulating layer, a first insulating film and a second insulating film formed with different insulating materials on the coil pattern, and a magnetic member formed to enclose the insulating layer, the coil pattern and the first and the second insulating films. By forming thin dual insulating films having a high adhesive strength and breaking strength on an inductor coil, it is possible to improve Ls characteristics of the inductor device and increase the inductance.

### CROSS-REFERENCE TO RELATED APPLICATION(S)

This application claims the benefit under 35 USC §119(a) of Korean Patent Application No. 10-2015-0048218, filed with the Korean Intellectual Property Office on Apr. 6, 2015, the entire disclosure of which is incorporated herein by reference for all purposes.

### BACKGROUND

1. Field

The following description relates to an inductor and a method of manufacturing the same.

2. Description of Related Art

An inductor device is a passive devices constituting an electronic circuit, a resistor, and a capacitor. The inductor device may be used in a power circuit, such as a DC-DC converter. The inductor device may also be used in electronic equipment, to remove noise, or to form an LC resonance circuit. As multitasking capabilities for activities such as, for example, communication, camera, and game are increasingly in today's smartphones and tablet PCs, there has been a growing use of power inductors to reduce power loss and to enhance power efficiency.

While inductor devices are of multilayer types, coil types and film types, the film type inductor devices have been increasingly used as electronic equipment have been smaller and thinner.

As the electronic equipment has become smaller and thinner, there has been a growing demand for smaller and thinner inductor devices, with a same or greater level of inductance and Q values. Accordingly, there have been ongoing efforts for developing a material such as, for example, ferrite having a higher saturation magnetization value, or increasing the area of coil wiring through a printing technique for increasing an aspect ratio between a width and a thickness of the coil wiring, or through a structural technique for forming a high aspect ratio.

The coil type inductor may be formed by winding a coil on, for example, a ferrite core. In the coil type inductor, a stray capacitance may occur in between the coil, and thus the number of coil winding have to be increased to obtain a high inductance.

The multilayer type inductor may have a plurality of ceramic sheets, which are laminated. In the multilayer type inductor, a coil type of metal pattern is formed on each ceramic sheet, and the metal patterns may be successively connected to one another through conductive vias disposed on the ceramic sheets. The multilayer type inductor is better suited for mass production and has a better high-frequency property than the coil type inductor.

The film type inductor has been increasingly studied recently because materials having a high saturation magnetization value can be utilized, it is relatively easier to form an internal circuit pattern compared to the multilayer type inductor, even if the film type inductor is manufactured in a small size.

The related art of the present description is disclosed in U.S. Patent Publication No. US 2009-0207576. All documents cited in the present disclosure, including published documents, patent applications, and patents, may be incorporated herein in their entirety by reference in the same manner as when each cited document is separately and specifically incorporated or incorporated in its entirety.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect there is provided an inductor device that may improve Ls characteristics of an inductor and increase an inductance by forming thin dual insulating films having a high adhesive strength and breaking strength on an inductor coil.

In another general aspect there is provided a method of manufacturing an inductor device that may improve Ls characteristics of an inductor and increase an inductance by forming thin dual insulating films having a high adhesive strength and breaking strength on an inductor coil.

In another general aspect there is provided an inductor device including an insulating layer, a coil pattern formed on two opposing surfaces of the insulating layer, a first insulating film and a second insulating film formed with different insulating materials on the coil pattern, and a magnetic member formed to enclose the insulating layer, the coil pattern and the first and the second insulating films.

The coil pattern maybe formed in an elliptical shape.

The first insulating film may be made of a material having a greater adhesive strength than a material of the second insulating film.

The second insulating film may be made of a material having a greater breaking strength than a material of the first insulating film.

The first insulating film and the second insulating film are formed using initiated chemical vapor deposition (iCVD).

The circuit pattern and a via may be formed on the insulating layer.

The inductor device may include a pair of external terminals formed on external surfaces of the magnetic member and the pair of external terminals maybe electrically connected with the coil pattern.

The inductor device may include a through hole formed to divide the insulating layer.

In another general aspect there is provided a method of manufacturing an inductor device including forming a coil pattern on two opposing surfaces of an insulating layer, forming a first insulating film and a second insulating film made of different materials on the coil pattern, and forming a magnetic member to enclose the first insulating film and the second insulating film, coil pattern, and insulating layer.

The forming of the magnetic member may include laminating a dry-film type sheet above and below the insulating layer, and pressing and curing the dry-film type sheet.

The first insulating film may be made of a material having a greater adhesive strength than a material of the second insulating film.

The second insulating film may be made of a material having a greater breaking strength than a material of the first insulating film.

The first insulating film and the second insulating film may be formed using initiated chemical vapor deposition (iCVD).

The iCVD may use a peroxide of tert-butyl peroxide (TBPO) or tert-amyl peroxide (TAPO) as an initiator.

The method may include forming a circuit pattern and a via on the insulating layer.

The method may include forming a pair of external terminals on external surfaces of the magnetic member, wherein the pair of external terminals may be electrically connected with the coil pattern.

The forming of the first insulating film may include forming the first insulating film by depositing the first insulating film on the coil pattern and a portion of the insulating layer where coil pattern is not formed.

The dry-film type sheet may be a composite of polymer with ferrite or metallic magnetic powder.

Other features and aspects will be apparent from the following detailed description, the drawings, and the claims.

### BRIEF DESCRIPTION OF DRAWINGS

FIG. 1 is a diagram illustrating an example of an inductor device.

FIG. 2 is a diagram illustrating an example of the inductor device.

FIG. 3 is a diagram illustrating an example of the inductor device.

FIG. 4 through FIG. 10 are diagrams illustrating examples of a method of manufacturing an inductor device.

FIG. 11 illustrates an example of a principle of deposition in an Initiated Chemical Vapor Deposition (iCVD) process used in a method of manufacturing an inductor device.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

Identical or corresponding elements will be given the same reference numerals, regardless of the figure number, and any redundant description of the identical or corresponding elements will not be repeated. Throughout the description of the present disclosure, when describing a certain relevant conventional technology is determined to evade the point of the present disclosure, the pertinent detailed description will be omitted. Terms such as “first” and “second” can be used in describing various elements, but the above elements shall not be restricted to the above terms. The above terms are used only to distinguish one element from the other. In the accompanying drawings, some elements may be exaggerated, omitted or briefly illustrated, and the dimensions of the elements do not necessarily reflect the actual dimensions of these elements.

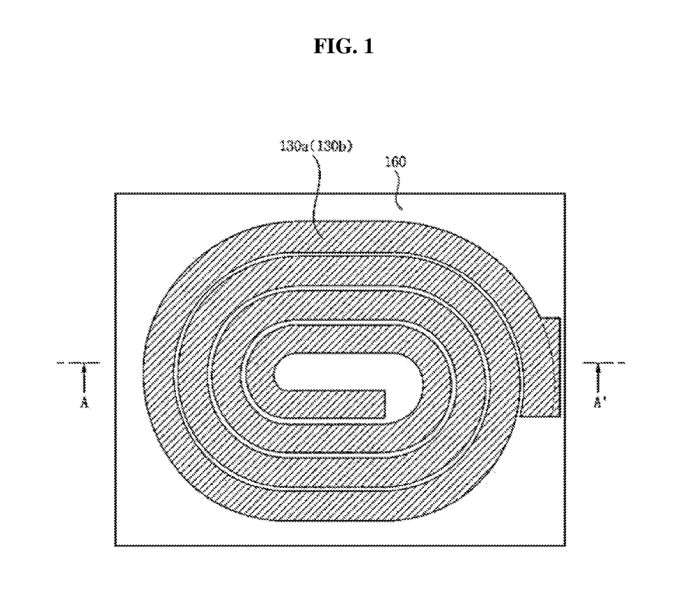

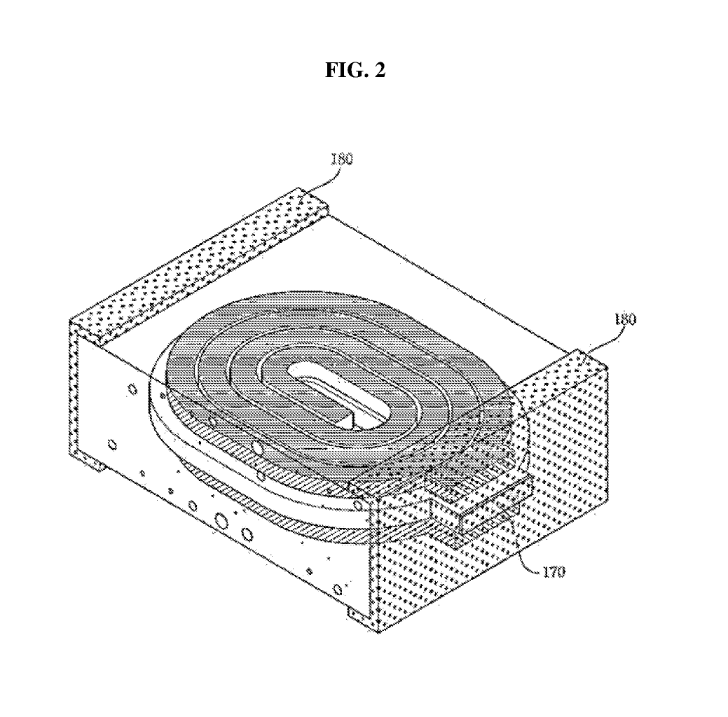

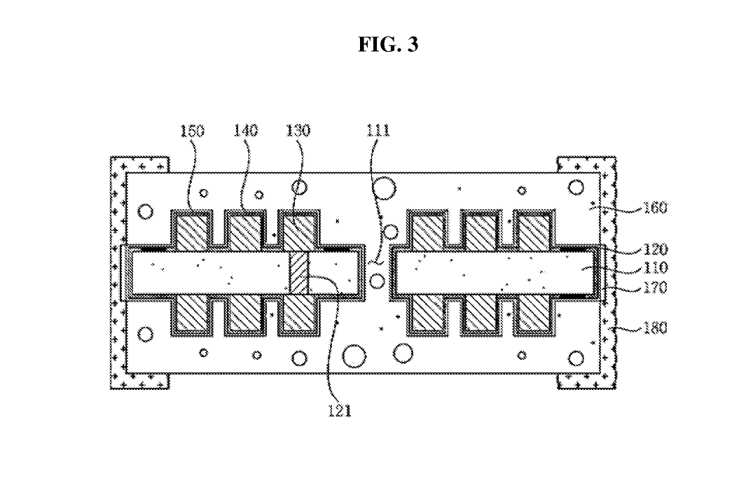

FIG. 1 is a diagram illustrating an example of an inductor device. FIG. 2 is a diagram illustrating an example of the inductor device. FIG. 3 is a diagram illustrating an example of the inductor device. As illustrated in FIG. 1 through FIG. 3, an inductor device includes an insulating layer 110, a coil pattern 130 formed on both surfaces of the insulating layer 110, dual insulating films 140 and 150 formed with different insulating materials on the coil pattern 130, and a magnetic member 160 for molding the aforementioned elements.

The insulating layer 110, which functions as a support layer for the coil pattern 130, has a through-hole 111 formed at a center and has a via 121. A circuit pattern 120 is formed on an upper surface and a lower surface of the insulating layer 110 for electrical connection with the coil pattern 130. In this example, since the insulating layer 110 is less magnetically permeable than a magnetic material, the through-hole 111 may inhibit a serial resistance value from increasing while preventing an inductance value from dropping due to an insufficient circulation of flux.

The insulating layer 110 may be formed as a prepreg layer, and may be made of a thermosetting or thermoplastic polymer material, a ceramic, an organic or inorganic composite material, or any resin having glass fiber impregnated therein. When the insulating layer 110 is made of a polymer resin, the polymer resin may include an epoxy insulation resin, such as, for example, flame retardant 4 (FR-4), bismaleimide triazine (BT) or an ajinomoto build-up film (ABF). In another example, the polymer resin may include a polyimide resin, but the present disclosure is not limited thereto.

The coil pattern 130 is formed with a thickness of about 100-200 μm using a conductive metallic material, such as, for example, copper, above and below the insulating layer 110. The coil pattern 130 is formed in a generally spiral structure but may be formed in a circular shape, an elliptical shape or a polygonal shape, such as, for example a rectangular, pentagonal or hexagonal shape, or in an irregular shape. However, as illustrated in FIG. 1 to FIG. 3, the coil pattern 130 may have a maximum area to maximizing the intensity of an induced magnetic field, by being formed in an elliptical shape in the inductor device.

The coil pattern 130 is connected with an input/output pattern 170 for electrical input and output. The input/output pattern 170 is formed on a lateral surface of the insulating layer 110 for electrical connection with an external terminal 180 formed outside the magnetic member 160.

The dual insulating films 140 and 150 are constituted with a first insulating film 140, which is made of a first insulating material, and a second insulating film 150, which is made of a second insulating material. The first insulating film 140 is made of a material having a greater adhesive strength than that of the second insulating film 150 to function as a seed layer on the coil pattern 130.

For example, the first insulating film 140 may be made of a material such as, for example, silane polymer, amine polymer, imidazole polymer, pyridine polymer or a combination thereof, but the present disclosure is not limited thereto.

Moreover, the second insulating film 150 is made of a material having a greater breaking strength than the first insulating film 140. For example, the second insulating film 150 may be made of a material such as, for example, a organosilicon polymer, superhydrophobic polymer, hydrophilic polymer or hydrophobic polymer, but the present disclosure is not limited thereto.

The first insulating film 140 and the second insulating film 150 are formed using initiated chemical vapor deposition (iCVD) to form a thin insulating film and to reduce a rate of wave form defects.

The magnetic member 160 may be formed by laminating a dry-film type of sheet, made of a composite of polymer with ferrite or metallic magnetic powder, above and below the insulating layer 110, on which the dual insulating films 140 and 150 are formed, or by casting a paste made of the aforementioned material.

Formed at either end of the magnetic member 160 are a pair of external terminals 180 that are electrically connected with the input/output pattern 170.

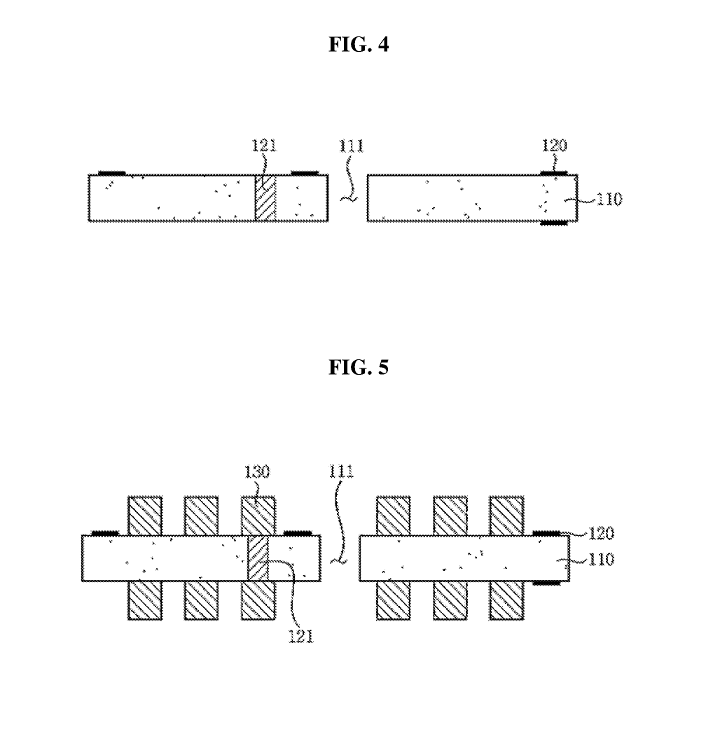

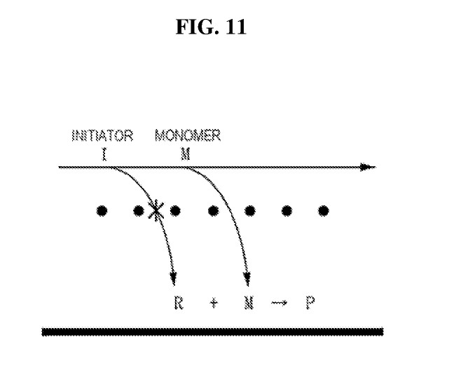

FIG. 4 through FIG. 10 are diagrams illustrating examples of a method of manufacturing an inductor device. FIG. 11 illustrates an example of a principle of deposition in an iCVD process used in a method of manufacturing an inductor device. The inductor device used in this example is described above and illustrated in FIG. 1 to FIG. 3. The above description of FIGS. 1-3, is also applicable to FIGS. 4-10, and is incorporated herein by reference. Thus, the above description may not be repeated here.

As illustrated in FIG. 4, a circuit pattern is formed on both surfaces of an insulating layer. A through-hole 111 is formed at a center of an insulating layer 110. A via 121 is formed in the insulating layer 110 and a circuit pattern 120 is formed on an upper surface and a lower surface of the insulating layer 110.

In this example, since the insulating layer 110 is less magnetically permeable than a magnetic material, the through-hole 111 may inhibit a serial resistance value from increasing while preventing an inductance value from dropping due to an insufficient circulation of flux. The through-hole 111 may be formed using a laser drill.

The circuit pattern 120, which is configured to apply an electric signal to a coil pattern, is formed by selectively removing a metal layer formed on the upper surface and the lower surface of the insulating layer 110. In an example, the circuit pattern 120 may be formed using a subtractive process, which is an etching process. In another example, the circuit pattern 120 may be formed using an additive process, which uses electroless and/or electrolytic copper plating, and/or a semi-additive process.

In an example, the insulating layer 110 may be formed as a prepreg layer, and may be made of a thermosetting or thermoplastic polymer material, a ceramic, an organic or inorganic composite material, or any resin having glass fiber impregnated therein. When the insulating layer 110 is made of a polymer resin, the polymer resin may include an epoxy insulation resin, such as, for example, flame retardant 4 (FR-4), bismaleimide triazine (BT), or an ajinomoto build-up film (ABF). In another example, the polymer resin may include a polyimide resin, but the present disclosure is not limited thereto.

As illustrated in FIG. 5, a coil pattern 130 is formed on both surfaces of the insulating layer 110.

The coil pattern 130 is formed with a thickness of about 100-200 μm using a conductive metallic material, such as, for example, copper, above and below the insulating layer 110. In an example, the coil pattern 130 is formed by selectively removing a metal layer. In an example, the coil pattern 130 may be formed using a subtractive process, an additive process, which uses electroless and/or electrolytic copper plating, and/or a semi-additive process.

The coil pattern 130 is formed in a generally spiral structure but may be formed in a circular shape, an elliptical shape or a polygonal shape, such as, for example, rectangular, pentagonal or hexagonal shape, or in an irregular shape. As illustrated in FIG. 1 to FIG. 3, the coil pattern 130 may have a maximum area, hence maximizing the intensity of an induced magnetic field, by being formed in an elliptical shape in the inductor device.

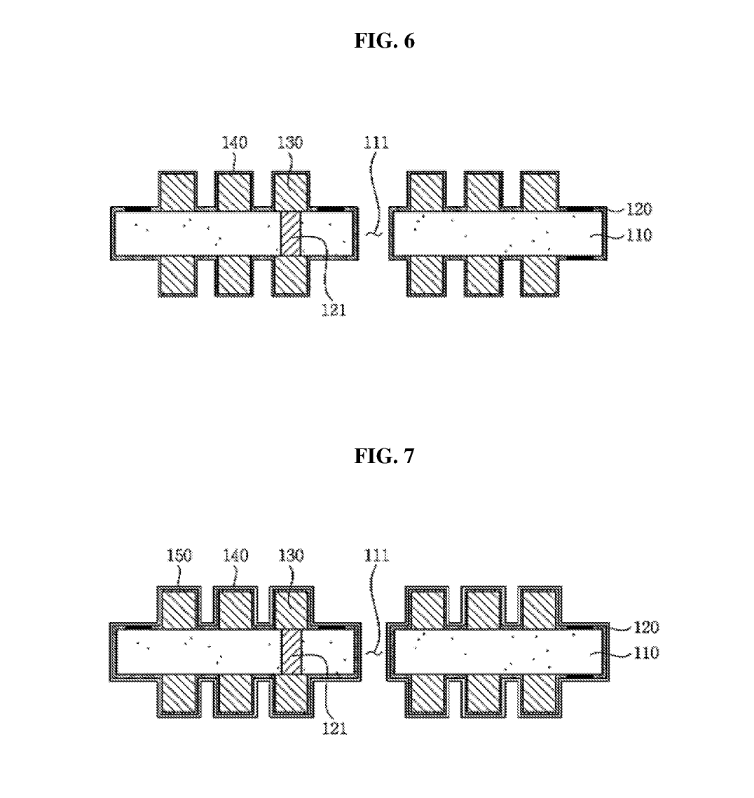

As illustrated in FIG. 6, a first insulating film 140 is formed on the coil pattern 130 using iCVD. The first insulating film 140 is made of a material having a greater adhesive strength than that of a second insulating film. The first insulating film 140 is made of a strongly adhesive insulating material to function as a seed layer on the coil pattern 130. For example, the first insulating film 140 may be made of a silane polymer, an amine polymer, an imidazole polymer, a pyridine polymer, or a combination thereof, but the present disclosure is not limited thereto.

By forming the first insulating film 140 using the iCVD method, it becomes possible to form a thin insulating film and to reduce a rate of wave form defects. As illustrated in FIG. 11, in the iCVD method, a thin polymer film P may be formed through a vapor phase polymerization, in which a deposition process and a polymerization reaction of polymer are simultaneously undertaken by vaporizing a monomer M of polymer forming an AP film within a chamber. The iCVD method may allow the thin polymer film P to be deposited on surfaces of the coil pattern 130 and the insulating layer 110 by enabling a chain polymerization reaction using a free radical R in a vapor phase by vaporizing an initiator I and the monomer M.

In this example, the initiator I and the monomer M have no polymerization reaction when the initiator I and the monomer M are simply mixed, but when the initiator I is decomposed and the radical R is generated by a hot filament placed within an iCVD chamber, the monomer M is activated, causing the chain polymerization reaction. The initiator I, for which a peroxide such as tert-butyl peroxide (TBPO) or tert-amyl peroxide (TAPO) is often used, is a volatile material having a boiling point of about 110° C. and a pyrolysis temperature of about 150° C.

By maintaining the filament used in the iCVD chamber at about 200-250° C., the chain polymerization reaction may be readily induced. In this example, the temperature of the filament is sufficiently high for pyrolysis of the peroxide initiator I but not for pyrolysis of most organic materials including the monomer M used in iCVD.

The free radical R formed through the decomposition of the initiator I may be transferred to the monomer M for chain reaction, resulting in formation of polymer P. The formed polymer P may be laminated on the insulating layer 110, which is maintained at a low temperature, to form the AP film.

As illustrated in FIG. 7, a second insulating film 150 is formed on the first insulating film 140. The second insulating film 150 is made of a material that is stronger than the first insulating film 140, or the second insulating film 150 has a greater breaking strength than that of the first insulating film 140. For example, the second insulating film 150 may be made of a material such as, for example, organosilicon polymer, superhydrophobic polymer, hydrophilic polymer, or hydrophobic polymer, but the present disclosure is not limited thereto. Like the first insulating film 140, the second insulating film 150 is formed using iCVD.

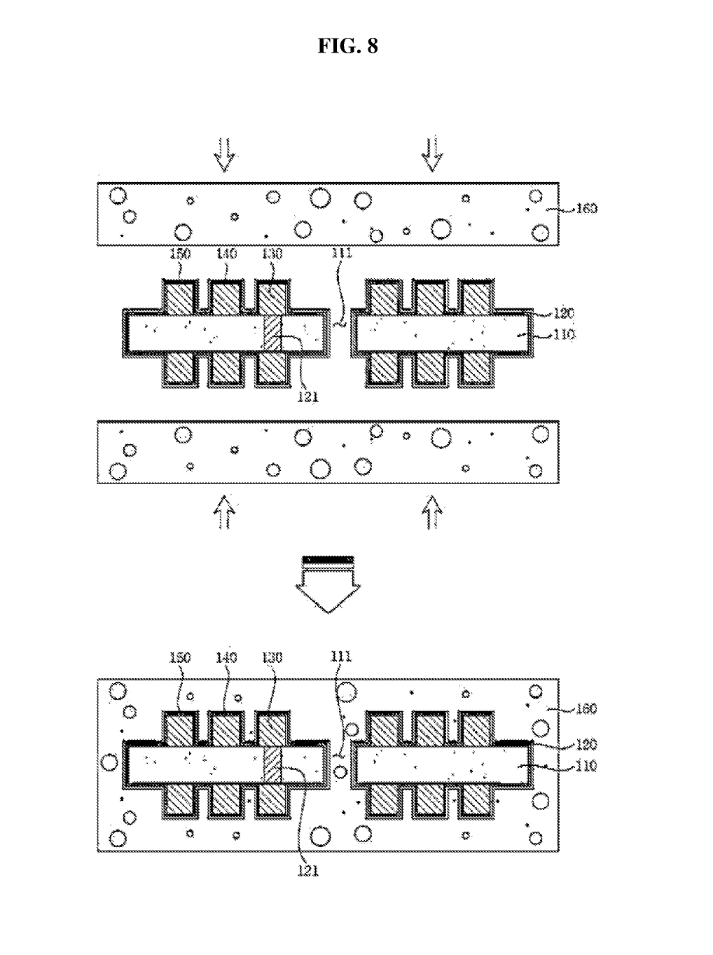

As illustrated in FIG. 8, a magnetic member 160 is formed such that the formed first insulating film 140 and second insulating film 150 are enclosed in the magnetic member 160.

In an example, the magnetic member 160 may be formed by laminating a dry-film type of sheet, made of a composite of polymer with ferrite or metallic magnetic powder, above and below the insulating layer 110, on which the first insulating film 140 and the second insulating film 150 are formed. In another example, the magnetic member 160 may be formed by casting a paste made of the aforementioned material.

After laminating the dry-film type, magnetic sheet above and below the insulating layer 110, a pressing process is carried out, followed by primary curing and secondary curing.

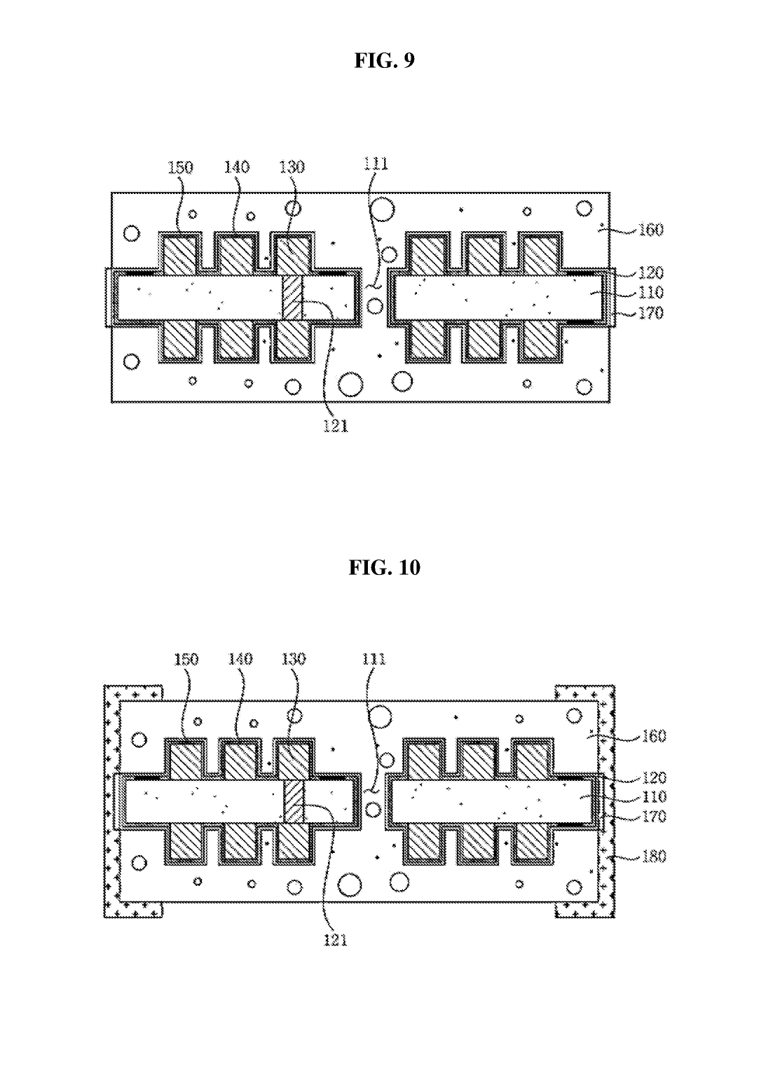

As illustrated in FIG. 9, dicing, polishing and grinding processes are successively carried out to expose a lateral portion of the insulating layer 110 from the cured magnetic member 160. An input/output pattern 170 is formed on the lateral portion of the insulating layer 110. The input/output pattern 170 is a coil electrode being electrically connected with the coil pattern 130,

As illustrated in FIG. 10, a pair of external terminals 180, which are electrically connected with the input/output pattern 170, are formed on the end portions of the magnetic member 160.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An inductor device comprising:
an insulating layer;
a coil pattern formed on two opposing surfaces of the insulating layer;
a first insulating film and a second insulating film formed with different insulating materials on the coil pattern; and
a magnetic member formed to enclose the insulating layer, the coil pattern and the first and the second insulating films.

2. The inductor device of claim 1, wherein the coil pattern is formed in an elliptical shape.

3. The inductor device of claim 1, wherein the first insulating film is made of a material having a greater adhesive strength than a material of the second insulating film.

4. The inductor device of claim 1, wherein the second insulating film is made of a material having a greater breaking strength than a material of the first insulating film.

5. The inductor device of claim 1, wherein the first insulating film and the second insulating film are formed using initiated chemical vapor deposition (iCVD).

6. The inductor device of claim 1, wherein a circuit pattern and a via are formed on the insulating layer.

7. The inductor device of claim 1, further comprising a pair of external terminals formed on external surfaces of the magnetic member and the pair of external terminals are electrically connected with the coil pattern.

8. The inductor device of claim 1, further comprising a through hole formed to divide the insulating layer.

9. A method of manufacturing an inductor device, comprising:
forming a coil pattern on two opposing surfaces of an insulating layer; forming a first insulating film and a second insulating film made of different materials on the coil pattern; and
forming a magnetic member to enclose the first insulating film and the second insulating film, coil pattern, and insulating layer.

10. The method of claim 9, wherein the forming of the magnetic member comprises:
laminating a dry-film type sheet above and below the insulating layer; and
pressing and curing the dry-film type sheet.

11. The method of claim 9, wherein the first insulating film is made of a material having a greater adhesive strength than a material of the second insulating film.

12. The method of claim 9, wherein the second insulating film is made of a material having a greater breaking strength than a material of the first insulating film.

13. The method of claim 9, wherein the first insulating film and the second insulating film are formed using initiated chemical vapor deposition (iCVD).

14. The method of claim 13, wherein the iCVD uses a peroxide of tert-butyl peroxide (TBPO) or tert-amyl peroxide (TAPO) as an initiator.

15. The method of claim 9, further comprising forming a circuit pattern and a via on the insulating layer.

16. The method of claim 9, further comprising forming a pair of external terminals on external surfaces of the magnetic member, wherein the pair of external terminals are electrically connected with the coil pattern.

17. The method of claim 9, wherein the forming of the first insulating film comprises forming the first insulating film by depositing the first insulating film on the coil pattern and a portion of the insulating layer where coil pattern is not formed.

18. The method of claim 10, wherein the dry-film type sheet comprises a composite of polymer with ferrite or metallic magnetic powder.
